(19) United States
(12) Patent Application Publication
(10) Pub. No.: US 2009/0000224 A1
(43) Pub. Date: Jan. 1, 2009

(54) Pultruded door frame

(75) Inventor: Lawrence Frank Kerscher, DePere, WI (US)

Correspondence Address: WILHELM LAW SERVICE, S.C., 100 W LAWRENCE ST, THIRD FLOOR, APPLETON, WI, 54911, US

(73) Assignee: Bay Industries, Inc., Green Bay, WI (US)

(21) Appl. No.: 12/229,763

(22) Filed: Aug. 26, 2008

Related U.S. Application Data
(63) Continuation-in-part of application No. 11/015,237, filed on Dec. 17, 2004.
Application No. 11/015,237 is a continuation-in-part of application No. 10/109,759, filed on Mar. 28, 2002, now Pat. No. 7,111,433.
(60) Provisional application No. 60/355,592, filed on Feb. 7, 2002.

(51) Int. Cl. E06B 1/04

(52) U.S. Cl. 52/204.1

(57) ABSTRACT

A fiber-reinforced pultruded polymeric door frame has side and header jamb assemblies which are essentially devoid of wood and other materials which are susceptible to being damaged by the affects of weather. Such jamb assembly generally includes a pultruded jamb which has a rearwardly- and/or downwardly opening cavity. Inserts are received in the jamb cavities and extend downwardly and/or rearwardly from the pultruded jambs. The inserts can receive nails or screws, whereby the door frame can be mounted to building framing members at the doorway rough opening.

### CROSS-REFERENCE TO RELATED APPLICATIONS

This application is a Continuation-in-Part of application Ser. No. 11/015,237, filed Dec. 17, 2004, which is a Continuation-in-Part of application Ser. No. 10/109,759, filed Mar. 28, 2002, now U.S. Pat. No. 7,111,433, both of which are herein incorporated by reference in their entireties. Application Ser. No. 10/109,759 is the non-provisional of application Ser. No. 60/355,592, filed Feb. 7, 2002. Accordingly, this application claims priority under 35 U.S.C. 120 to application Ser. No. 11/015,237, to application Ser. No. 10/109,759, and to application Ser. No. 60/355,592.

### BACKGROUND

This invention pertains to prefabricated and otherwise assembled generally maintenance-free door frames.

When installing a door frame into a doorway opening in a building, it is desirable to have a strong, durable, rot and decay resistant, frame which is either prefabricated or easily assembled at the construction site. Preferably, the frame can be assembled at an off-site manufacturing location. In the alternative, it is desirable to have frame elements which are easily assembled at the construction site.

In a typical construction project involving personnel entry doors, door frames are fabricated by a frame fabricator, and are thence shipped to a door assembler. The door assembler receives the frames as fabricated, and assembles e.g. the frames to respective door slabs. The slabs are also commonly purchased separately from slab manufacturers. The door assembler adds the desired e.g. transparent and/or translucent e.g. glass, inset, if any, to the door slab, assembles the door slab to a selected door frame, and ships the thus assembled door, including frame and slab, to the construction site for installation in the building.

In the known art, the basic frame of the door is commonly wood. The door assembler can up-grade the quality and value of the frame, and thus the quality and value of the door assembly, to some extent, by installing generally maintenance-free cladding elements to the left, right, and top frame wood substrate members, thus to provide maintenance free, tough, and durable exterior surfaces to the frame.

However, even where the jamb substrate is up-graded with e.g. aluminum cladding, the properties of the wood substrate still have substantial affect on the use life, and ongoing properties of the door frame. Such wood substrate can be subject to attack by rot, insects, and other invasive organisms which cause the properties of the wood to deteriorate.

For example, the bottom of the wood frame commonly is directly adjacent an underlying surface such as concrete, dirt, or the like. Where the door frame is mounted as an exterior entrance to a building, the outwardly-disposed side of the door frame is subjected to the weather, including rain, snow, changes in temperature, changes in humidity, and the like. Such environmental conditions are detrimental to the long-term stability of the wood substrate. As a first example, the wood readily absorbs and holds water. So any rain can be a source of moisture which is absorbed by that portion of the wood which is close to the underlying ground or concrete.

The moisture, as absorbed, can be wicked upwardly into a few inches of the wood. While present in the wood, the moisture supports bacteria or other life forms which feed on the substances of the wood, causing loss of strength in the wood. Over a period of time, and with repeated such exposures to water, the wood eventually decays to a form commonly known as rotten wood. Rotten wood does not have the structural qualities of wood which has not been so decayed, whereby the resulting door frame does not provide the desired degree of support for the door, and the frame fails.

Wood is also subject to attack by insects, which also causes structural deterioration of the wood, and thus deterioration of support for the door.

Such failed door frame can be replaced or repaired. However, it would be preferable to avoid the deterioration which accompanies wood structures at the doorway.

### SUMMARY

Thus, it is desirable in the invention to provide door jambs and door frames which are not subject to deleterious effects such as those which are visited on wood by weather, by bacteria, and/or by insects or other deleterious life forms.

It is also desirable in the invention to provide door jambs and door frames which are made with materials all of which withstand weather, bacteria, and insects for substantially longer periods of time than wood which is subjected to the same conditions.

This invention provides a door frame which employs jambs or jamb assemblies which are essentially devoid of wood and other materials which are so exposed as to be susceptible to being damaged by the affects of weather, bacteria, and/or insects in those areas of the frame which will be subjected to the outside ambient environment. Thus, the side jambs are fabricated of fiber-reinforced pultruded moldings which moldings extend in some embodiments from e.g. the floor, concrete, or other underlying substrate, to the header, which header can be fabricated from a fiber-reinforced pultruded molding having a profile in common with the side jambs. A nosing can be provided with the pultruded jamb molding, either integral with the pultruded polymeric jamb molding or snap assemblable to the pultruded polymeric jamb molding. The pultruded jamb molding can include a nail fin kerf at or adjacent an outer panel of the jamb, or on the nosing, whereby the door frame can include a nailing fin. Such nailing fin can be a rigid e.g. aluminum molding nailing fin, or can be a flexible e.g. polymeric nailing fin. An elongate e.g. polymeric insert can be provided, assembled to the pultruded polymeric molding, and extending along the length of the pultruded polymeric molding, which insert can receive nails or screws, optionally without pre-drilling, in much the same manner as wood receives nails or screws in fastening wood to an adjacent substrate or other structure. Nails and/or screws can thus be driven through the insert and into adjacent framing members of the building, thus to mount the door frame, and thus the door, to the building.

In a first family of embodiments, the invention comprehends a door jamb adapted to be received into a rough opening defined by framing in a building. The door jamb has a length, a rough opening side adapted and oriented to face into the rough opening when the door jamb is mounted to the building at the rough opening, and an opposing side adapted and oriented to face away from the rough opening, the door jamb comprising a fiber-reinforced pultruded polymeric molding, the pultruded molding defining a pultruded jamb element having a length and a rear, and comprising a first jamb side panel adapted and oriented to face toward the rough opening and having a first terminal end at the rear of the jamb element, a second jamb side panel adapted and oriented to face away from the rough opening and having a second terminal end at the rear of the jamb element, an outer jamb panel adapted and oriented to face outwardly of the building, and a rear cavity extending along the length of the pultruded jamb element, the rear cavity having a rearwardly-facing opening.

In some embodiments the door jamb further comprises an inner jamb panel adapted and oriented to face inwardly into the building at or proximate a rear of the pultruded jamb element, and wherein ones of the first jamb side panel, the second jamb side panel, the outer jamb panel, and the inner jamb panel generally define a second cavity therebetween, the second cavity being disposed outwardly of the building relative to the rear cavity, such that the rear cavity is generally between the second cavity and the interior of the building.

In some embodiments, the rear cavity extends along the length of the pultruded jamb element, and the rear cavity is defined in part by first and second cavity side panels, and the rear cavity is further defined by a front cavity panel disposed between the outer panel and the rear of the pultruded jamb element, the rear-facing opening comprising an elongate opening extending, along a substantial portion of the length of the pultruded jamb element, into the rear cavity, between the first and second side panels at the rear of the pultruded jamb element.

In some embodiments, the door jamb further comprises an insert in the rear cavity, the insert extending rearwardly of the pultruded polymeric jamb element, composition of the insert being such that the insert can be fastened to the building by driving fasteners through the insert at locations disposed rearwardly of the pultruded polymeric jamb element.

In some embodiments, the door jamb further comprises locking structure on the pultruded jamb element, extending outwardly of the building from the outer panel.

In some embodiments, the insert is made of hydrophobic polymeric resin, optionally including filler material, and the insert does not readily absorb substantial quantity of water.

In some embodiments, the locking structure comprises first locking structure, and the door jamb further comprises a pultruded polymeric nosing, which nosing defines second locking structure, locking the pultruded nosing to the jamb element at the first locking structure.

In some embodiments, the door jamb further comprises an inner jamb panel disposed rearwardly of the outer jamb panel, the rear cavity being defined at least in part by rear portions of the first and second jamb side panels, which rear portions of the first and second jamb side panels extend rearwardly from the inner jamb panel to first and second terminal ends thereof, the rear portions of the jamb side panels having protuberances extending therefrom, into the rear cavity and toward the other of the rear portions of the jamb side panels, the protuberances optionally being displaced from the first and second terminal ends of the rear portion of the first and second jamb side panels.

In some embodiments, the door frame is a garage door frame. In other embodiments, the door frame is an entry door frame.

In a second family of embodiments, the invention comprehends a door frame adapted to be mounted in a rough opening in a building. The door frame comprises first and second side jamb assemblies, and a header jamb assembly extending between the first and second side jamb assemblies. At least one of the side jamb assemblies has a fiber-reinforced pultruded polymeric upper member and a lower member, the pultruded upper member having a length, and a first lower end, and defining at least one cavity extending along the length thereof, the lower member defining an upper portion received into the cavity and a lower extension portion extending downwardly from the first lower end of the upper member to a second lower end of the extension portion a distance sufficient to substantially avoid travel of liquid water from the second lower end of the extension portion to the first lower end of the upper member, the extension portion being defined by a durable, rot resistant and decay resistant material.

In some embodiments, the insert portion extends along a substantial portion of the length of the upper member.

In some embodiments, a portion of the lower member abuts against an edge or surface of the upper member of the jamb assembly.

In some embodiments, the pultruded upper member extends along a substantial portion of the length of the side jamb assembly.

In some embodiments the pultruded polymeric upper member comprises a jamb member having an outer panel adapted and oriented to face outwardly, away from the building, the pultruded polymeric upper member further comprising a nosing adapted and oriented to extend outwardly, away from the building relative to the outer panel, the nosing and the jamb member being defined in a common unitary body.

In some embodiments, the header jamb assembly has an end which defines a joint with one of the first and second side jamb assemblies, further comprising a clip which extends across the joint, and which clip engages locking elements in the upper member of the respective side jamb assembly and in the header jamb assembly, thereby to control movement of a respective end of the header jamb assembly and the corresponding end of the respective side jamb assembly with respect to each other, in directions toward and/or away from the building.

In some embodiments, the upper member has a first side panel adapted and oriented to face into the rough opening, a second side panel adapted and oriented to face away from the rough opening, an outer jamb panel adapted and oriented to face away from the building, and an inner panel adapted and oriented to face inwardly into the building, a rear of the upper member extending rearwardly of the inner panel to terminal ends of the first and second side panels, the insert portion of the lower member extends along the length of the upper member, and rearwardly of the terminal ends of the first and second side panels.

In a third family of embodiments, the invention comprehends a door frame adapted to be mounted in a rough opening in a building, the door frame comprising first and second side jamb assemblies, and a header jamb assembly extending between the first and second side jamb assemblies. At least one of the first and second side jamb assemblies and the header jamb assembly, comprises a fiber-reinforced pultruded polymeric jamb element having a length, and comprising a first jamb side panel adapted and oriented to face toward the rough opening, a second jamb side panel adapted and oriented to face away from the rough opening, a jamb outer panel adapted and oriented to face outwardly of the building, and a jamb inner panel adapted and oriented to face inwardly into the building at or proximate a rear of the pultruded polymeric jamb element, the fiber-reinforced pultruded polymeric jamb element comprising a pultrusion extending substantially the entirety of the length of the jamb assembly, the at least one side jamb assembly being supported by the pultruded polymeric jamb element, from an underlying support, within a distance of the underlying support which would enable travel of liquid water through wood over the distance, by surface tension, from a lower edge of the side jamb assembly to the pultruded polymeric jamb element. The door frame further comprises a header extending between the first and second side jamb assemblies.

In some embodiments, the at least one side jamb assembly further comprises a cavity extending along the length of the pultruded jamb element and open to the rear of the respective side jamb assembly, the cavity being adapted to receive thereinto a rearwardly-extending insert.

In some embodiments, the door frame further comprises an insert in the cavity, the insert extending along a substantial portion of the length of the pultruded jamb element, the insert having a front disposed toward the outer panel and a back disposed away from the outer panel and toward the rear of the jamb element, the insert being defined by a durable, rot resistant, and decay resistant, material which is receptive to nails and/or screws, as fasteners to fasten said insert to such building.

In some embodiments, the cavity extends along a substantial portion of the length of the pultruded jamb element, and the cavity is defined at least in part by the first and second side panels and the inner panel, an elongate opening extending along a substantial portion of the length of the pultruded jamb element and into the cavity, between terminal ends of the first and second side panels at the rear of said pultruded jamb element.

In some embodiments, the rear of the pultruded jamb element extends rearwardly of the inner panel to terminal ends of the first and second side panels, the insert extending, along the length of the jamb element, rearwardly of the terminal ends of the first and second side panels.

In a fourth family of embodiments, the invention comprehends a door jamb, having a length, and being adapted to be received into a rough opening in a building, the door jamb comprising a fiber-reinforced pultruded polymeric molding. The molding comprises a door jamb element having a length, and being adapted to be assembled into a door jamb, such door jamb being adapted to be received into a rough opening in a building, the door jamb element comprising a first jamb side panel adapted and oriented to face toward the rough opening, a second jamb side panel adapted and oriented to face away from the rough opening, a jamb outer panel adapted and oriented to face outwardly away from the building, and a jamb inner panel adapted and oriented to face inwardly into the building; and a nosing element, integral with the jamb element and adapted and oriented to extend outwardly of the building from the outer panel of the jamb element, along a substantial portion of the length of the jamb element.

### BRIEF DESCRIPTION OF THE DRAWINGS

FIG. 1 shows a pictorial view of a first embodiment of door frames of the invention, with parts cut away, as a garage door in a frame, with the garage door partially lifted.

FIG. 2 shows a cross-section of a first embodiment of door jambs, including integral nosing structure, used in door frames of the invention.

FIG. 3 shows a cross-section of a brick mold casing which can be mounted to the door jamb of FIG. 2.

FIG. 4 shows a cross-section of an assembly of the jamb of FIG. 2 and the brick mold casing of FIG. 3.

FIG. 5 shows a cross-section of an extended-width flat add-on casing which can be mounted to the jamb of FIG. 2.

FIG. 6 shows a cross-section of an assembly of the casing of FIG. 5, the jamb of FIG. 2, and a durable elongate insert received in an open-ended cavity of the jamb.

FIG. 6A shows the assembly of FIG. 6, and further includes a brickmold casing mounted to the extended-width casing.

FIG. 7 shows an orthogonal-view cross-section of the jamb assembly generally as in FIG. 1, and is taken at 7-7 of FIG. 1.

FIG. 8 shows an end view of an “L-shaped” spring clip which can be used at mitered corners of jamb elements used in door frames of the invention.

FIG. 9 shows a bottom view of the spring clip of FIG. 8.

FIG. 10A shows a pictorial view of an introverted perpendicular-angle corner gusset which can be employed at right-angle corners of door frame assemblies of the invention.

FIG. 10B shows a pictorial view of an extroverted perpendicular angle corner gusset which can be employed at right-angle corners of door frame assemblies of the invention.

FIG. 11 shows an enlarged front elevation view of an upper corner of a garage door frame of the invention, with parts cut away, incorporating the corner gusset of FIG. 10A, and is taken at dashed circle 11 in FIG. 1.

FIG. 12 shows a rear view of the upper corner of the door frame of FIG. 11, as seen from inside the building.

FIG. 13 shows an edge view of a corner gusset which is employed in jamb elements at 45-degree angle corners of a door frame of the invention.

FIG. 14 shows an enlarged front elevation view of an upper corner as in FIG. 11 and wherein the corner structure includes use of 45-degree angle corner structure.

FIG. 15 shows a cross-section of a second embodiment of door jamb assemblies of the invention, showing a second embodiment of the jamb, including a durable, elongate non-wood insert received in a rearwardly-open rear cavity of the jamb.

FIG. 16 shows a cross-section of a third embodiment of door jamb assemblies of the invention, showing a third embodiment of the jamb, including a durable, elongate non-wood insert received in a rearwardly-open rear cavity of the jamb.

FIG. 17 shows a cross-section of a fourth embodiment of door jamb assemblies of the invention, showing a fourth embodiment of the jamb, including a durable, elongate non-wood insert received in a rearwardly-open rear cavity of the jamb.

FIG. 18 shows a cross-section of a further embodiment of door jambs of the invention, wherein the durable, insert-holding, rearwardly-open rear cavity has been deleted; and wherein registered mounting holes have been added along the length of the jamb, to opposing faces of the jamb.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

As used herein, the terms “pultrude”, “pultruded”, and “pultrusion” refer to products and known processes of such nomenclature wherein fibrous reinforcing materials are pulled through polymer infusion work-stations, forming work-stations, and setting/curing work-stations in fabricating generally continuous-length fiber-reinforced polymeric moldings.

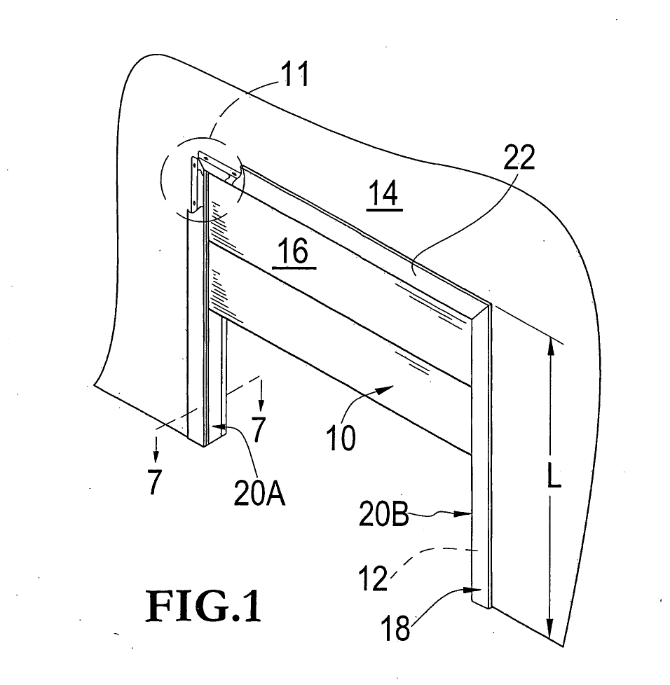

Turning now to the drawings, FIG. 1 shows a garage door 10 mounted in a rough opening 12 in a building 14. As illustrated, the garage door is partially open, such that only two of the commonly-used four garage door panels 16 are visible.

FIG. 1 shows, in general, a door frame 18, which includes left and right side jamb assemblies generally designated 20A, 20B respectively and a header assembly 22 extending across the top of the rough opening and connected to the two side jamb assemblies. The side jamb assemblies and the header assembly have generally common cross-sections, whereby the description of one of the side jamb assemblies is effective to describe the header assembly and the other side jamb assembly. The rough opening, and correspondingly the finished opening, is sized, adapted, and configured to cooperate with a door to be used in combination with the frame. Thus, when the frame is used in entry door applications, the distance between the side jamb assemblies has a magnitude of at least about 2 feet 8 inches up to about 42 inches for a single entry door, larger for a double door. Alternatively, when the frame is used in vehicle door applications, such as for garage doors, the distance between the side jamb assemblies has a magnitude of at least about 5 feet, at least about 7 feet, at least about 8 feet, for example about 15 feet, about 16 feet, or about 18 feet, and others.

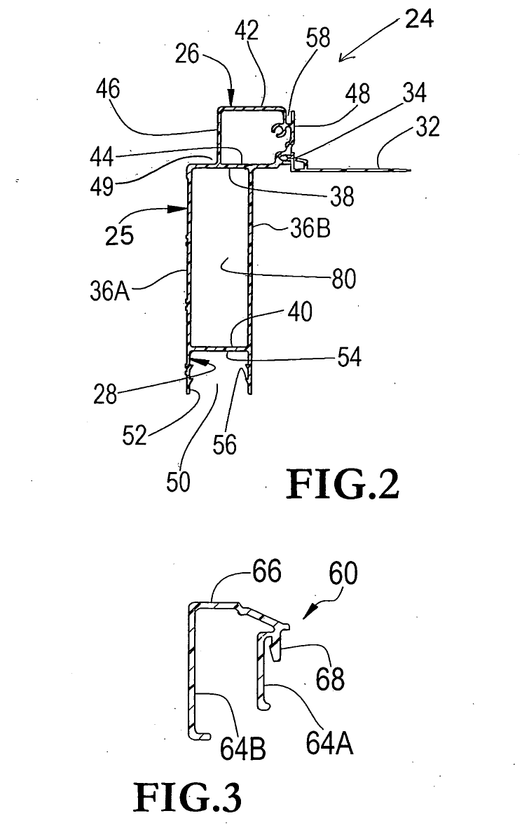

FIG. 2 shows a fiber-reinforced pultrusion in the form of a jamb 24, having a jamb element 25 and a nosing element illustrated as integral nosing 26 whereby the jamb element and the nosing elements together, at least partially, define the generally common unitary body of the jamb.

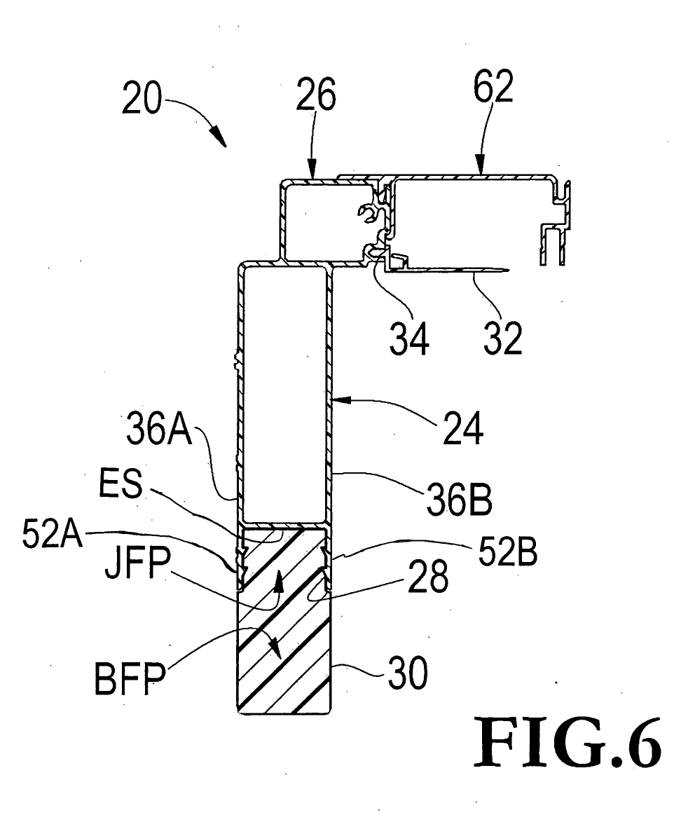

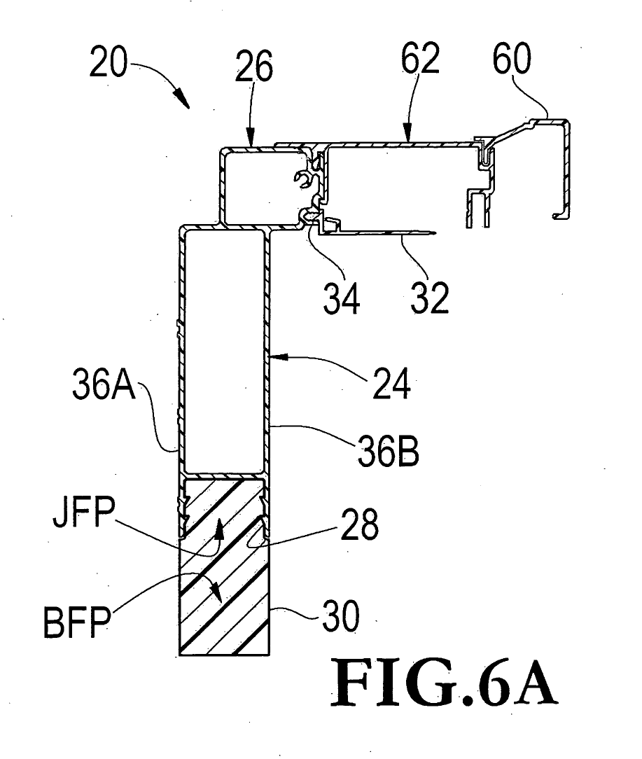

Jamb 24 further includes a cavity 28 adapted to receive a generally polymeric insert 30 (FIG. 6). A nailing fin 32 is shown mounted in a nailing fin receptacle, namely in fin kerf 34, generally at the boundary between nosing element 26 and jamb element 25. Jamb element 25 is generally defined by left 36A and right 36B side panels, outer panel 38, and inner panel 40. In the assembled, installed, jamb 24, the left side panel 36A faces into the doorway opening and right side panel 36B faces the building framing members which define the rough opening. Outer panel 38 faces outwardly of the building and inner panel 40 faces inwardly toward the inside of the building.

Nosing element 26 is defined by outer wall 42, inner wall 44, and sides 46, 48. In the embodiment of FIG. 2, the inner wall of the nosing element and the outer panel of the jamb element are each defined in part by a common strip of material at the boundary between the nosing and the jamb. Side 46 of the nosing element faces into the doorway opening and is located away from the rough opening, relative to jamb element left side panel 36A. Side 46 of the nosing element and outer panel 38 of the jamb element collectively define a recessed area 49 which can receive e.g. an outer door structure such as a storm door or a screen door.

Rear cavity 28 defines an elongate opening 50 open to the rear of the jamb and extending along a substantial portion of the length of the jamb, optionally along substantially the full length of the jamb, optionally along the entirety of the length of the jamb. Cavity 28 is in general defined by left and right side walls 52, which are extensions of side panels 36A and 36B, by front wall 54 which corresponds to inner panel 40 of the jamb element, as well as being defined in part by opening 50. Thus, left and right side walls 52 at least partially define a rearmost portion, e.g. rear, of the polymeric pultruded/molded jamb element, at or adjacent, for example their terminal ends which are distal the remaining components of jamb 24.

Protuberances 56, project into the cavity from side walls 52. Protuberances 56 are designed with abutting surfaces which extend generally perpendicularly relative to side walls 52, and face toward nosing element 26, and are designed to interface with corresponding rearwardly-facing surfaces of insert 30, which rearwardly-facing surfaces can be parts of channels, grooves, chamfers, bevels, or other inward projections and/or other structure, formed into or extending from insert 30, which insert structure mechanically interfaces with protuberances 56 thereby to impede withdrawal of the insert from the cavity toward the rear of the jamb, namely toward the interior of the building.

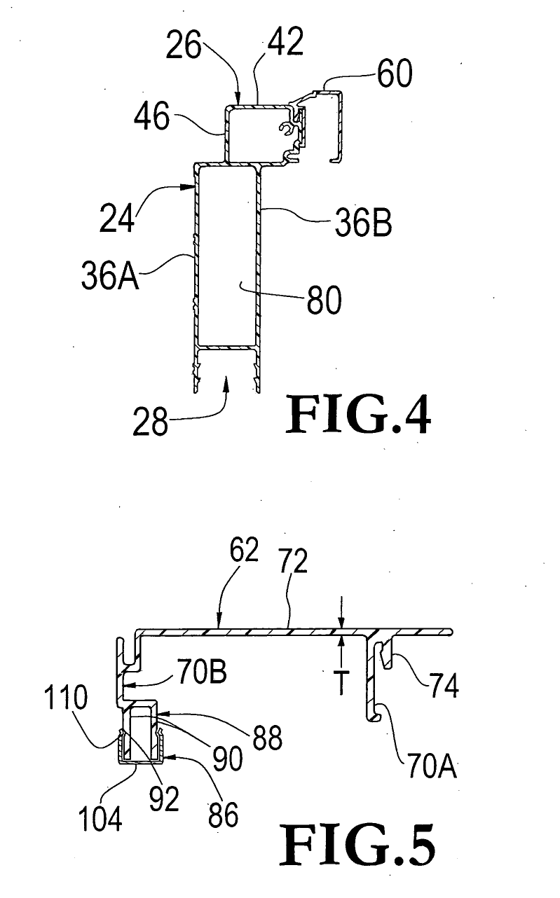

An elongate recess 58, e.g. a casing-receiving structure, extends along the length of the nosing element, proximate the outer surface of the nosing element, and is adapted to receive, and hold, an elongate casing such as a brick mold 60 or a generally flat casing, e.g. extended-width casing 62 (FIG. 5). FIG. 3 illustrates a brick mold casing 60. Casing 60 includes right and left side walls 64A, 64B and an outer wall 66. An elongate mounting stub 68 extends parallel to, and offset from, side wall 64A and extends away from outer wall 66. Stub 68 is sized and configured to mount to nosing element 26 at elongate recess 58, thereby to mount the casing to the nosing element by frictional engagement between the nosing element and the casing. FIG. 4 shows brickmold casing 60 mounted to jamb 24 at elongate recess 58.

FIG. 5 shows extended-width flat casing 62. Casing 62 includes right and left side walls 70A, 70B, and an outer wall 72. Mounting stub 74 extends parallel to, and offset from, side wall 70A and extends away from outer wall 72. Stub 74 is sized and configured to fit into, and to mount to, nosing element 26 at elongate recess 58, thereby to mount casing 62 to the nosing element by frictional engagement between the nosing and the casing. In the assemblage of casing 62 and jamb 24 to each other, the outer, flat, surface of outer wall 72 is approximately co-planar with an outer surface of the nosing element of jamb 24, as illustrated in FIG. 6. As can be seen by comparing FIGS. 4 and 6, in general, casing 60 or casing 62, but not both, may be mounted to a given casing-receiving structure such as recess 58.

Referring now to FIGS. 1, 6, 6A, and 7, a given side jamb assembly 20 typically includes a pultruded polymeric jamb 24, and can include a nosing element 26 integral with the jamb or, as discussed hereinafter, attached to the jamb as a separate element. A casing 60 or 62 can be mounted to the jamb as illustrated in FIGS. 4 and 6. FIG. 6A shows casing 62 mounted to the jamb and casing 60 mounted to casing 62. Such casings can be mounted directly to jamb element 25, or can be indirectly mounted to the jamb through the nosing element. A nailing fin 32 can be mounted directly to the building framing or framing elements, as well as to the jamb, or to the nosing, or to the casing where a kerf is provided in the respective jamb element, nosing element, or casing.

Insert 30, which is received into rear cavity 28, is made with a durable, rot resistant, decay resistant, and insect resistant, material and can be mounted in the jamb to serve as a stiffening member, and/or to serve as an attachment structure, whereby the jamb assembly can be nailed or screwed to one or more building framing members. Referring to FIG. 6, insert 30 has a jamb facing portion “JFP” and a building facing portion “BFP”. Jamb facing portion “JFP” of insert 30 generally faces and communicates with jamb 24, and building facing portion “BFP” of insert 30 generally faces toward the interior of the building when the door frame has been installed in the building. As illustrated in e.g. FIG. 6, a terminal end surface ES of jamb facing portion “JFP” interfaces with, abuts, and/or otherwise communicates with cavity front wall 54.

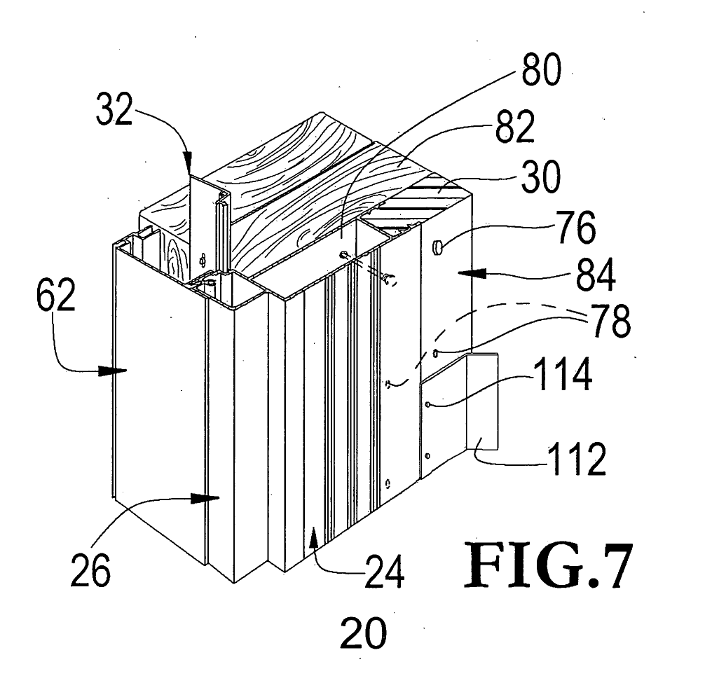

In the embodiment illustrated in FIGS. 6 and 7, at least part of jamb facing portion “JFP” of insert 30 has a width dimension which is of lesser magnitude than the width dimension of the building facing portion “BFP”. Preferably, the difference in the magnitudes of the widths of jamb facing portion “JFP” and building facing portion “BFP” corresponds to the magnitude of the sum of the thickness dimensions of left and right cavity sidewalls 52.

Thus, when insert 30 is received in rear cavity 28, the outer surface of left cavity side wall 36A and the portion of the outer surface of the left side of insert 30 which extends beyond left side wall 52A generally collectively define a generally continuous flat surface e.g. with no substantial step-change in surface profile height along at least a major portion of the collective surface, allowing for a joint line where the end of the cavity side wall meets a stepped portion of the left wall of the insert. Likewise, when insert 30 is housed in cavity 28, the outer surface of right side wall 52B and the portion of the outer surface of the right side of insert 30 which extends beyond right side wall 52B generally collectively define a generally continuous flat surface e.g. with no substantial step-change in surface profile height along at least a major portion of the collective surface, allowing for a joint line where the end of the cavity side wall meets a stepped portion of the left side wall of the insert.

Also as illustrated, the jamb facing portion “JFP” has at least one interfacing structure which is adapted and configured to interface with the inwardly-facing protuberances of the cavity sidewalls 52. In the illustrated embodiments, each of the interfacing structures in the insert is a “V-type” groove, which has first and second terminally intersecting groove walls. One of the groove walls extends generally perpendicularly into insert 30 and the other of the groove walls extends into insert 30 at a non-perpendicular angle. Other interfacing structures, adapted to provide the interface feature between insert 30 and side walls 52A, 52B, are contemplated and are within the scope of the invention, including, but not limited to, channels, grooves, chamfers, bevels, and/or other inward projections and/or other structure, formed into or extending from, insert 30 and/or side walls 52A, 52B.

Insert 30 can be disposed in a location generally toward the interior of the building such as inwardly of front wall 54 of cavity 28, and generally to the rear of jamb 24. In such instance, and as illustrated in FIG. 7, metal nails 76 or screws (not shown) can be driven through the insert much like metal nails and screws are commonly driven through wood structural members, since the insert extends along the length of the jamb element, and e.g. rearwardly of side walls 52A, 52B and since insert 30 can accept metal fasteners and/or other hardware therethrough.

Depending on the material composition of insert 30, and the structure of the respective nails or screws, mounting holes 78 may or may not be pre-drilled or punched, as round or slotted holes in insert 30. Where a softer material such as polyethylene, or a soft nylon or the like is used for insert 30, pre-drilled holes are generally not required. Where a harder material such as polycarbonate or an acrylic is used in fabricating insert 30, pre-drilled holes may be desirable.

Regarding materials from which insert 30 can be fabricated, there can be mentioned for example and without limitation, various of the polyethylenes, polyamides such as nylon, vinyl, acrylic, certain polyurethanes, and polycarbonate. Typically, a generally hydrophobic polymeric material is selected as the base material for use in insert 30. As additional compositional ingredients, there can be mentioned a wide array of additives and fillers which can be used to enhance the properties of the resultant insert, and/or to reduce the cost of the insert. In general, any additive such as a filler must be compatible with the polymeric resin, and the proportion of the ingredients must be such that the polymeric resin is sufficiently continuous in the combination to prevent substantial absorption of water into any one or more components of the finished combination product. Suitable fillers include, but are not limited to, wood particles, other cellulosic material, fibrous material, other organic and/or inorganic fillers, combinations thereof, and others.

Thus, in general, the polymeric resin is a continuous phase in the combination, and any hygroscopic filler or other inclusions are discontinuous inclusions in the continuous resin phase. A modest level of foaming, namely voids, is acceptable in insert 30 so long as the hydrophobic properties, and all structural requirements, of the insert are preserved.

The rib which extends between the left 36A and right 36B side panels of the jamb serves both as the inner wall 40 of the jamb 24 and as the front wall 54 of rear cavity 28. In some embodiments, the insert, or a portion of the insert, or a second insert, can be disposed frontwardly of the inner panel 40 of the jamb, which corresponds to the front wall 54 of the rear cavity, thus between inner panel 40 and outer panel 38. Where the insert is disposed frontwardly of the inner wall of the jamb, the insert is desirably, but not necessarily, disposed proximate the inner wall. In such instance, and contrary to the illustration of FIG. 7, where a single insert 30 is used, the insert is located inside the tubular front cavity 80 defined between side panels 36A, 36B, outer panel 38, and inner panel 40.

Mounting holes 78, shown in dashed outline in FIG. 7, are optionally pre-drilled through the fiber-reinforced pultruded polymeric side panels 36A, 36B of jamb 24 as well as through insert 30 (illustrated in solid outline), a set of the mounting holes through side panels 36A, 36B, and insert 30 at a given location along the length of the jamb being in registration with each other, whereupon a nail or screw can be driven through insert 30, including through side panels 36A, 36B, generally along a straight line path, and into the respective framing members 82 of the building which define the rough opening in the building. Such aligned, registered sets of holes are spaced from each other along the length of the jamb.

In the embodiments illustrated in FIGS. 1, 6, 6A, and 7, insert 30 generally fills rear cavity 28 between left and right walls 52, and extends to the rear of the cavity, and to the rear of the jamb, by a sufficient distance to provide a substantial nailing surface 84 for driving nails or screws through the insert and into framing members 82 of the building well ahead (outwardly of the building) of the inward edges of the framing members.

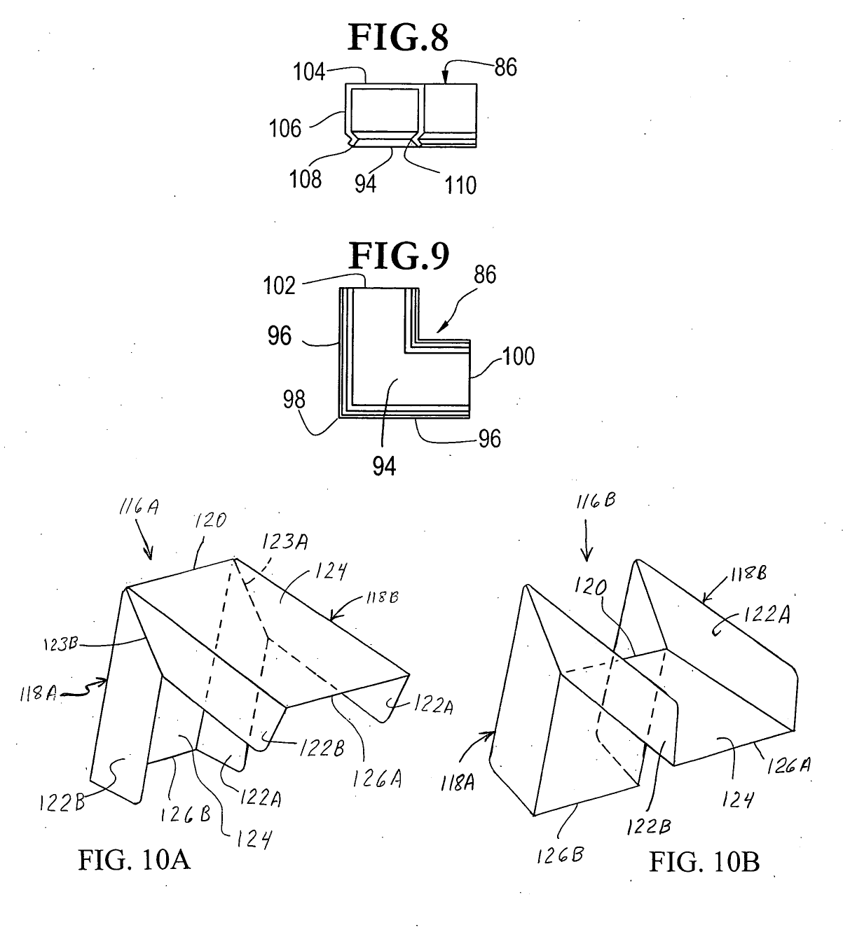

FIG. 5 shows a cross-section of extended-width casing 62 which, as discussed above, can be received into elongate recess 58 in nosing element 26. A spring clip 86, illustrated in more detail in FIGS. 8 and 9, is shown assembled to the casing in FIG. 5. The assembly of the extended-width casing to the nosing element is illustrated in FIG. 6. Assembly of spring clip 86 to the casing is illustrated in FIG. 5. As illustrated there, outer side wall 70B of casing 62 includes an elongate mounting fork 88 having a pair of elongate tines 90 extending along the length of the casing. Each tine has an elongate channel 92 extending along the length of the casing, along the length of the tine, at the outside surface of the tine, and spaced from a distal edge of the respective tine.

Referring still to FIGS. 5, 8, and 9, spring clip 86 generally defines an “L-shaped” channel 94 having first and second legs 96 which meet at a corner 98. FIG. 8 shows a view from the end of one of the legs of the spring clip. FIG. 9 shows a view from the open-channel side of the spring clip. Referring specifically to FIG. 9, in general, channel 94 extends at a constant cross-section from a first end 100 at a first one of the legs through and around corner 98 to a second end 102 at the second one of the legs. As viewed in FIG. 8, channel 94 has a top wall 104, and two downwardly-depending side walls 106 which terminate at distal ends 108. Each side wall 106 has an inwardly-projecting ridge 110 which constricts the width of the channel proximate the distal ends of the legs, namely near the open bottom of the channel.

Referring, now to FIG. 5, the ridges 110 in the side walls of the spring clip are resiliently received in outwardly-facing channels 92 of tines 90 of elongate mounting fork 88, whereby the ridges and channels cooperate in holding the spring clip generally immovably mounted to the casing at the upper frame corners. FIG. 12 shows the corner structure of the frame, with the spring clip mounted to forks 88 of the respective casings on the corresponding header jamb assembly and side jamb assembly, as viewed from inside the building, looking outwardly of the building through the doorway which is being framed by frame 18. FIG. 12 shows that the spring clip bridges the corner joint 111 of frame 18, which is defined between one of the side jamb assemblies and the header jamb assembly.

In the assemblage of a side jamb assembly 20 and header jamb assembly 22, first and second miter joints are defined at the intersection of side jamb assembly 20A and the header jamb assembly 22, and at the intersection of side jamb assembly 20B and header jamb assembly 22. The mitered portion of such side jamb assembly 20 and the mitered portion of header jamb assembly 22 interface with each other and are snugly held in generally immovable such interfacing relationship by ones of spring clips 86. Accordingly, spring clips 86 control movement of respective ends of header jamb assembly 22 and the corresponding side jamb assembly 20 with respect to each other, in a direction toward and/or away from such building, and/or in a direction generally toward and/or away from the rough opening which extends through the building.

Stated another way, the first and second legs of the spring clip resiliently grip the outwardly disposed surfaces of the respective mitered ends of the extended casing 62 at tines 90, at the corner defined by a side jamb assembly and the header jamb assembly. Since ridges 110 are at a common distance from top wall 104 on both legs, since channels 92 are located a cooperating common distance from the distal ends of the tines, the ridges gripping the tines at channels 92 positively seat the spring clips on the respective casings, on the header jamb and on the side jamb relative to each other such that the outside surfaces of the respective header casing and side casing are located in a common surface profile which extends longitudinally, in a direction generally parallel to the outer surface of the building. Stated another way, the spring clip holds the two mitered ends of the casing flush with each other, at a common distance from the outer surface of the building.

Referring to FIG. 6, polymeric flexible nailing fin 32 is mounted/held in nailing fin kerf 34 in the nosing, under the extended-width casing. Accordingly, the nailing fin is commonly nailed, or otherwise mounted, to the building framing before extended-width casing 62 is installed in recess 58 of the nosing element.

FIG. 7 illustrates the jamb assembly of FIG. 6 mounted to a double stud structure, illustrated as the two adjacent framing members 82, of the building frame using nails 76, either through insert 30 as shown, or as indicated in dashed outline, through pre-drilled holes in side panels 36A, 36B of the jamb. FIG. 7 further illustrates a truncated length of weather stripping 112 mounted to the insert by e.g. nails 114, and adapted to interface with a garage door mounted in the frame opening. Nails 114 can be inserted through pre-punched or pre-drilled, round or slotted holes 78 in pultruded jamb 24 or insert 30, or can be driven through certain insert materials which have no pre-formed holes but which are susceptible of having nails driven therethrough.

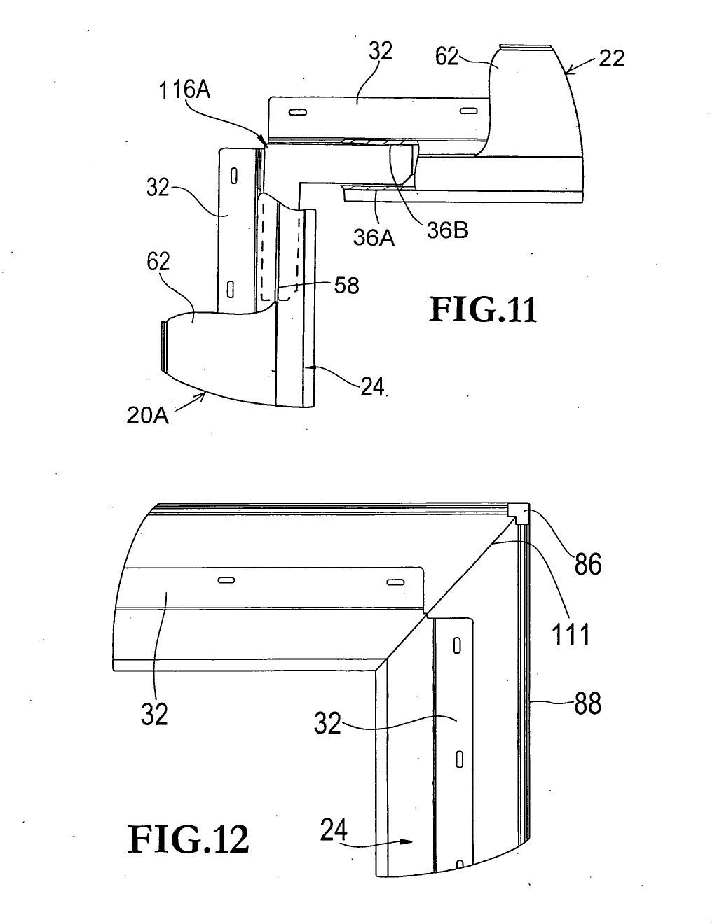

FIG. 10A shows a pictorial view of a pultruded L-shaped introverted, perpendicular corner gusset 116A which is used to join a side jamb assembly 20 to header jamb assembly 22. A such corner gusset is used at each of the corners 111 (FIGS. 11 and 12) at the tops of the respective side jamb assemblies, namely at, for example the miter joints. Gusset 116A includes a pair of legs 118A, 118B extending from a common corner 120.

Each leg is defined by an inner flange 122A, an outer flange 122B, and a bridging panel 124 which extends between the inner and outer flanges, and from corner 120 to distal ends 126A, 126B of the respective bridging panels. Inner and outer flanges 122A, 122B have generally the same configuration and are identified generally in terms of their inner or outer position, relative to each other when a door frame is installed in a building. The inner flanges 122A on a given gusset meet, and are joined to each other, at a joint 123A. Likewise, the 2 outer flanges 122B on a given gusset meet, and are joined to each other, at a joint 123B.

Each of the inner and outer flanges, and the bridging panels, are shown in pictorial view in FIG. 10A. The widths of bridging panels 124 extend generally from the outer panel 38 of the pultruded polymeric jamb 24 to the inner panel 40 of pultruded jamb 24, thus to generally span the cross-sectional dimensions of tubular front cavity 80, at the respective ends of the side jamb assembly and the header jamb assembly, with bridging panels 124 in close proximity to side panel 36B of jamb 24.

FIG. 10B shows a pictorial view of an alternate construction of the gusset, as a pultruded L-shaped extroverted, e.g. perpendicular corner gusset 116B which can be used, much like gusset 116A, at each of corners 111 (FIGS. 11 and 12) at the tops of respective side jamb assemblies, namely at, for example, the miter joints. Gusset 116B includes a pair of legs 118A, 118B extending from a common corner 120. Each leg is defined by an inner flange 122A, an outer flange 122B, and a bridging panel 124 which extends between the inner and outer flanges, and from common corner 120 to distal ends 126A, 126B of the respective bridging panels. Each of the inner and outer flanges, and the bridging panels, are shown in pictorial view in FIG. 10B. In the jamb assembly, the widths of bridging panels 124 extend generally from the outer panel 38 of the pultruded polymeric jamb 24 to the inner panel 40 of pultruded jamb 24, thus to generally span the cross-sectional dimension of tubular front cavity 80, at the respective ends of the side jamb assembly and the header jamb assembly, with bridging panels 124 in close proximity to side panels 36A of jamb 24.

As illustrated in FIGS. 11 and 12, the respective two legs of a gusset 116A are received in the respective tubular cavities of the side jamb and the header jamb at each of the respective corners 111 of the frame, and generally span the tubular cavities along much, optionally all, of the lengths of the legs of gusset 116A, thereby to mount the side jamb assemblies 20 to the header jamb assembly 22 at substantially perpendicular angles to the header assembly.

Gusset 116B can be used in the same capacity as gusset 116A, the only difference being the location of the bridging panels relative to the side panels 36A and/or 36B of the jamb as discussed above.

Chamfers and/or rounded corners, or angling of the ends of the respective legs, assist in aligning the legs with the tubular cavities as the gussets are installed in the respective cavities. Gussets 116A, 116B thus provide location and guidance to the side jambs and the header jamb during door frame assembly, and provide rigidity to the assembled frame at corners 111.

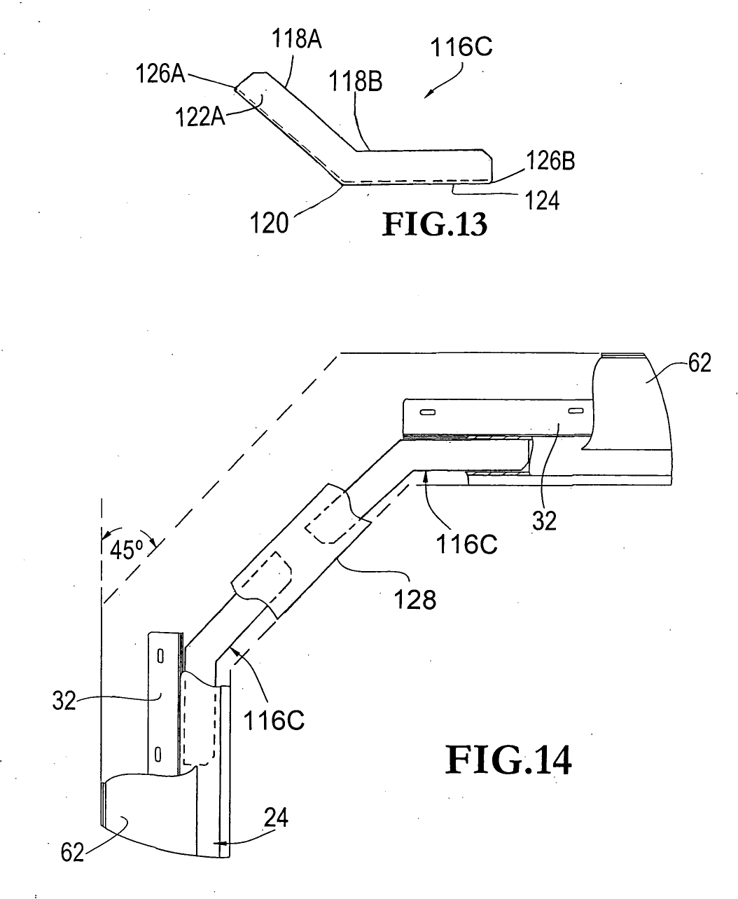

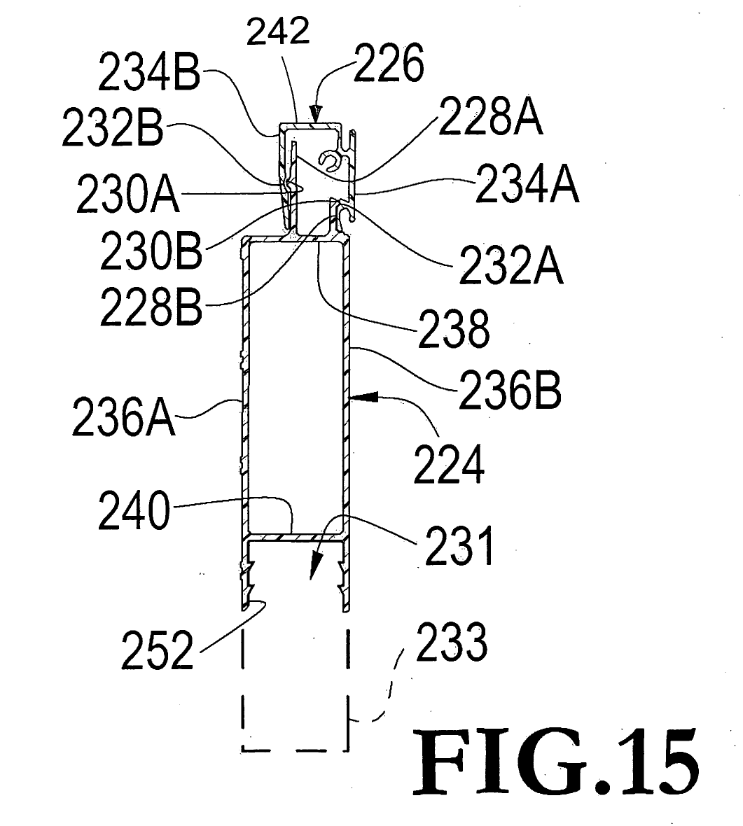

FIG. 13 shows a side elevation view of a third exemplary and introverted corner gusset, e.g. corner gusset 116C which is used to join a side jamb assembly 20 to header jamb assembly 22. A pair of such corner gussets is used at each of the corners 111 at the tops of the respective side jamb assemblies and in combination with an angled cross-member 126 (FIG. 14), namely at, for example the miter joints. Cross-member 128 has a pultruded profile, complementary to the profile of jamb 24.

Gusset 116C includes a pair of legs 118A, 118B extending from a common corner 120. Each leg is defined by an inner flange 122A, an outer flange (not shown), and a bridging panel 124, shown in edge view, which extends between the inner and outer flanges, and from corner 120 to distal ends 126A, 126B of the respective bridging panels.

The widths of bridging panels 124 extend generally from the outer panel 38 of the pultruded polymeric jamb 24 to the inner panel 40 of pultruded jamb 24, thus to generally fill the cross-sectional dimensions of tubular front cavity 80, at the respective ends of the side jamb assembly and the header jamb assembly, with bridging panels 124 in close proximity to side panel 36B of jamb 24. A similar but extroverted gusset (see FIGS. 10A, 10B) can be structured with bridging panels 124 in close proximity with side panel 36A of jamb 24.

As illustrated in FIG. 13, the respective two legs of gusset 116C are received in the respective tubular cavities of the side jamb and the cross-member 128 and/or in the tubular cavities of the header jamb and the cross-member at each of the respective corners of the frame, and generally fill the tubular cavities along much of the lengths of the legs of the gussets.

Chamfers and/or rounded corners, or angling of the ends of the respective legs, assist in aligning the legs with the tubular cavities as the gussets are installed in the respective cavities. Gussets 116C thus provide location and guidance to the side jambs and the header jambs during door frame assembly, and provide rigidity to the assembled door frame, at the frame corners, similar to gussets 116A, 116B.

Further, the location of bridging panel 124 can be positioned generally at will between the inner and outer flanges, so as to be located at any desired location between side panels 36A and 36B of jamb 24.

In the embodiment of FIG. 13, legs 118A, 118B define an included angle of about 135 degrees therebetween. Each cross member 128 thus defines an e.g. 45 degree angle facia across the 90 degree angle at the top of the door frame, at the respective corner of the rough opening, and the corresponding truncated corner facia is fabricated using legs 118A, 118B and bridging panels 124 as in gussets 116A, 116B. A pair of gussets shown in the corner assembly of FIG. 14 turns the full 90 degree corner, aided by cross-member 128 which is shown in part.

FIG. 15 shows a second embodiment of fiber-reinforced pultruded polymeric jambs 224 of the invention, including a narrow-profile fiber-reinforced pultruded nosing 226, as a separate and distinct element, snap locked to the outer panel of the pultruded jamb. Mounting structure and/or locking structure, namely legs 228A, 228B, extends outwardly from the outer panel of the pultruded jamb, and includes snap locks 230A, 230B on legs 228A, 228B which engage corresponding snap locks 232A, 232B on respective legs 234A, 234B of the nosing. Jamb 224 extends from outer panel 238 through side walls 236A, 236B to inner panel 240. Cavity 231 extends from inner panel 240 along cavity side walls 252 to the distal end of the cavity at the terminal ends of side walls 252. Nosing 226 extends from outer wall 242 to the distal ends of legs 228A, 228B. Polymer-based insert 233 is received in cavity 231 much like insert 30 is received in cavity 28.

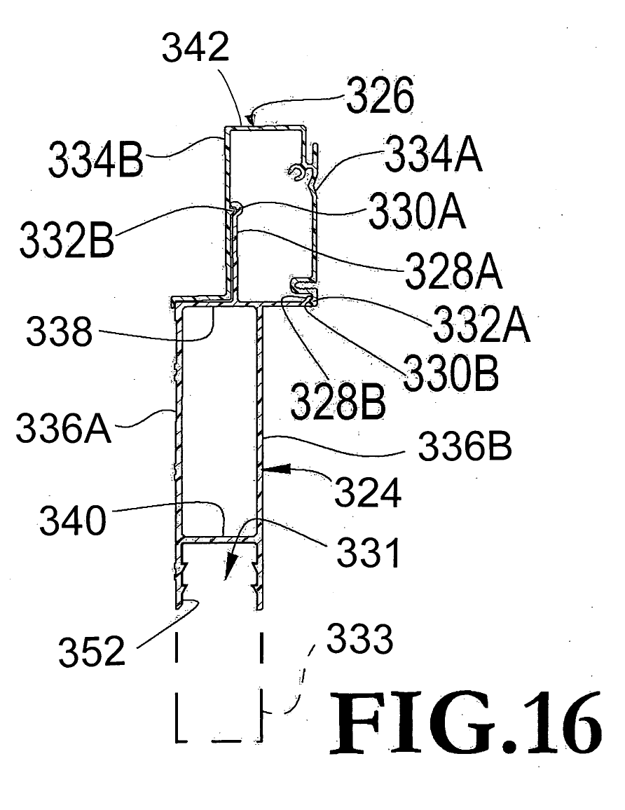

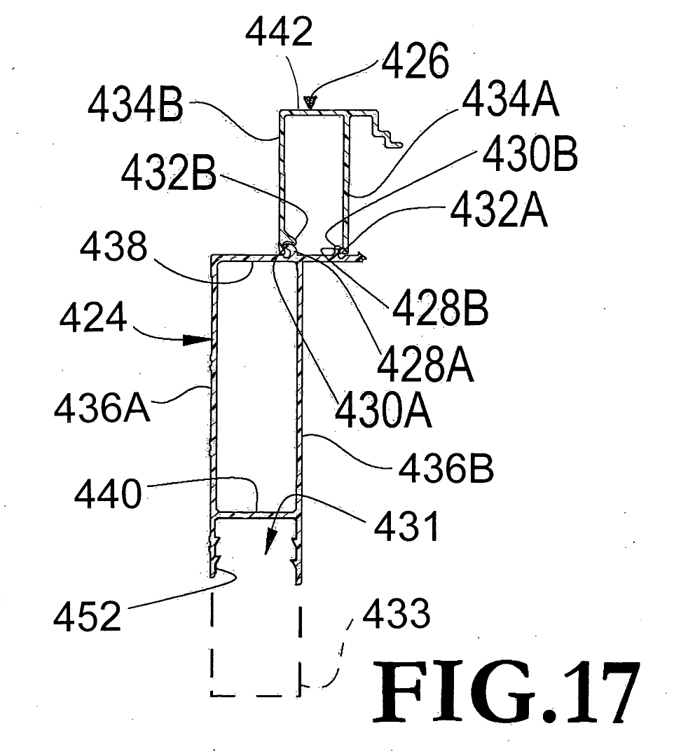

FIG. 16 shows a third embodiment of fiber-reinforced pultruded polymeric jambs of the invention, also including a relatively narrower-profile pultruded nosing 326, as a separate and distinct element, snap locked to the outer panel of the pultruded jamb. Namely, the embodiment of FIG. 16 shows yet another embodiment of pultruded polymeric jambs of the invention, again including a separate nosing. A durable polymer-based insert 333 is mounted in rearwardly open, rearwardly facing rear cavity 331 in the jamb of FIG. 16.

As illustrated in FIG. 16, in some exemplary embodiments, mounting structure and/or locking structure, namely legs 328A, 328B, extends outwardly from outer panel 338 of pultruded jamb 324, and includes snap locks 330A, 330B on legs 328A, 328B which engage corresponding snap locks 332A, 332B, on respective legs 334A, 334B of the nosing. Jamb 324 extends from outer panel 338 through side walls 336A, 336B to inner panel 340. Cavity 331 extends from inner panel 340 along cavity side walls 352 to the distal end of the cavity at the terminal ends of side walls. Nosing 326 extends from outer wall 342 to the distal ends of legs 328A, 328B. Insert 333 is received in cavity 331 much like insert 30 is received in cavity 28.

As in the embodiment of FIG. 15, the exemplary outer panel 338 of the jamb illustrated in FIG. 16 has first and second legs extending toward outer wall 342 of the nosing, and the nosing has a pair of legs which extend toward, and generally to, the outer panel of the jamb. In this embodiment, one of the nosing legs 334B also overlies the otherwise-exposed portion of the outer panel of the jamb. One leg on the outer panel of the jamb is quite short and ends at the nailing fin kerf. The other leg on the jamb is substantially longer. Both legs have snap lock structures at the ends of the legs. One of the legs on the nosing has snap lock structure which engages a leg of the jamb at the end of the nosing leg. The other leg of the nosing has snap lock structure mid-way of the height of the leg between outer wall 342 of the nosing and the outer panel 338 of the jamb.

FIG. 17 shows another embodiment of fiber-reinforced pultruded polymeric jambs of the invention, including a pultruded polymeric nosing 426 snap locked to the outer panel 438 of the pultruded jamb 424 as in FIGS. 15 and 16. The nosing includes a reverse-brick-mold configuration. The distal end of the outer panel 438 has a lock structure which can receive/snap lock a nailing fin.

As illustrated in FIG. 17, in some exemplary embodiments, mounting structure and/or locking structure, namely legs 428A, 428B extends outwardly from the outer panel 438 of the pultruded jamb, and snap locks 430A, 430B on legs 428A, 428B engage corresponding snap locks 432A, 432B on respective legs 434A, 434B of the nosing. Jamb 424 extends from outer panel 438 through side walls 436A, 436B to inner panel 440. Cavity 431 extends from inner panel 440 along cavity side walls 452 to the distal end of the cavity at the distal ends of side walls 452. Insert 433 is received in cavity 431 much like insert 30 is received in cavity 28 and inserts 233 and 333 are received in cavities 231 and 331 in FIGS. 15 and 16.

Thus, FIG. 17 shows still another embodiment of pultruded polymeric jambs of the invention, again including a separate nosing. In this instance, both legs extending from the jamb are quite short, such that the legs extend only far enough to form snap locks, such that the snap locks form substantially the entireties of the legs. Correspondingly, the nosing legs extend substantially the full height of the nosing between the nosing outer wall 442 and outer panel 438 of the jamb.

In general, the embodiments of FIGS. 15, 16, and 17 have common design with each other, as well as with the embodiments of FIGS. 4 and 6, when considered from, and excluding, the outer panel of the jamb to the back edge of the insert. Accordingly, the embodiments of FIGS. 15, 16, and 17 differ from each other, and from the embodiments of FIGS. 4 and 6, largely at the outer panel, at the nosing, at the nailing fin, and at the casing, if any. The various alternative structures offered with respect to FIGS. 4 and 6 inwardly of the outer panel can as well be applied to the embodiments of FIGS. 15, 16, and 17.

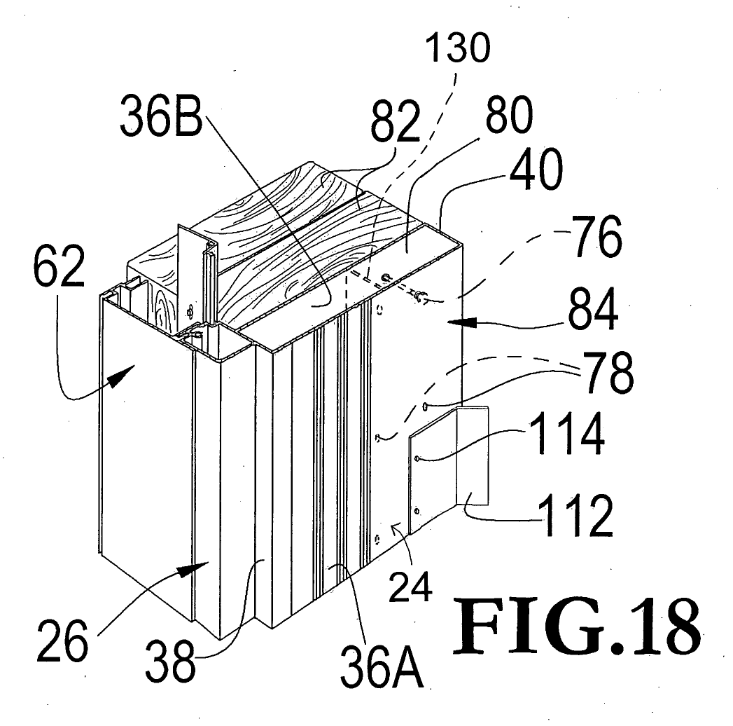

FIG. 18 shows yet another embodiment of fiber-reinforced pultruded polymeric jambs of the invention, which omits the rearwardly open cavity 28, 231, 331, 431 and rear insert 30, 233, 333, 433. In such embodiment, the width of jamb side panels 36 is relatively lengthened between outer panel 38 and inner panel 40 such that inner panel 40 is moved to the location which had been occupied by the back edge of the insert. As desired, one or more reinforcing webs 130, shown in dashed outline in FIG. 18 can extend between side walls 36A, 36B to provide additional side-to-side support in tubular cavity 80. Mounting holes 78 are pre-drilled, pre-formed in side panels 36A, 36B, optionally proximate a reinforcing web 130, so as to facilitate nailing or screwing the jamb to the framing members of the building. As seen in FIG. 18, in this embodiment, the nosing element is formed in common with the jamb element such that the nosing element and the jamb element are integral parts of the jamb. A snap-locked nosing can be used in place of an integral nosing, as exemplified in FIGS. 15-17.

Jamb 24, nosing 26, brick mold casing 60, extended width casing 62, and other moldings used in jamb assemblies of the invention are fiber-reinforced pultruded polymeric structures which have profile thicknesses “T” of about 0.04 inch to about 0.10 inch, with typical thicknesses of about 0.06 inch to about 0.09 inch, more typical thicknesses of about 0.075 inch to about 0.09 inch. The just-mentioned wall thicknesses apply to residential and light commercial uses of door frames of the invention. For heavier-duty implementations of the invention, including larger door openings and/or respectively more abusive use conditions, the profile wall thicknesses are made respectively more robust, such as by greater thicknesses of the pultruded walls. Those skilled in the art are now well aware of suitable pultrusion processes, e.g. mechanical and/or thermal treatments, and corresponding hardware, e.g. fiber feeds, dies, curing devices, pulling devices, and others, as well as levels of fiber reinforcement and wall thickness which can be used to achieve the desired hardness, rigidity, shape, abuse tolerance, and/or other properties of the resultant pultruded polymer-based product.

Door frame profiles of the invention are pultruded and formed as composite parts. For example, glass, or other reinforcing fibers, are impregnated with resin, and are pulled through one or more forming guides and a heated die. The forming guide influences the orientation and positioning of the fibers in the heated die so as to ensure that the resultant pultruded part has uniform and/or otherwise desired reinforcement profile properties across the resultant pultruded profile. The heated die cures and/or solidifies the resin around the reinforcing fibers, thus finishing the formation of the profile shape of the composite part and fixing the resultant profile of the so-produced, cured composite part. The composite part is continuously pulled out of the heated die by a puller. The force which pulls the cured part through the heated die is transmitted through the continuous-length fiber structure back through the forming guide to the fiber sources, such as creels of fiber product, which feed the fiber to the pultrusion process.

Reinforcing fibers used in pultruded products of the invention can be glass fiber, carbon fiber, kevlar fiber, and/or other organic or inorganic filaments and fibers. Reinforcing fibers can take the form of filament and strand bundles, called rovings. They also take the form of yarns, texturized yarns, chopped strand mats, continuous strand mats, knitted mats, woven mats, surfacing veils, and various combinations of rovings, yarns, mats, and veils, including stitching in respective ones of the fiber structures.

Resin used in pultruded products of the invention can be thermosetting resins such as unsaturated polyesters in styrene solution, or polyurethanes, or phenolics, or epoxies, or other thermosetting resins or thermosetting combinations. Exemplary other suitable resins are thermoplastic resins, such as those based on polyurethanes or acrylics, or polyethylenes or other polyolefins, and other thermoplastic resins. Resin used in pultruded products of the invention can also be thermoplastic resins which are embedded in or infused or injected into e.g. stitched woven fiberglass matts or other fiber structures and which, in softened or melted condition make at least substantial contribution to forming the profile of the pultruded part inside the pultrusion die.

Resin mixtures useful in the invention can also contain organic and/or inorganic additives, optionally polymeric additives, such as slip agents, anti-block agents, release agents, anti-oxidants, fillers, colorants, plasticizers, catalysts, accelerators, terminators, fillers, and others known to be useful in controlling or assisting in the processing of the polymeric material as well as to stabilize and/or otherwise control the properties of the finished processed product, such as to influence such parameters as shrinkage of the product, mold lubrication, hardness of the product, bending resistance of the product, and the like.

Insert 30, 233, 333, 433 is sized and configured for a tight fit in the respective rear cavity. Insert 30, 233, 333, 433 can be installed in the rear cavity by placing the insert alongside the cavity, in the same orientation as shown in e.g. FIGS. 6 and 15, and then pushing laterally toward front wall 54. Generally, pressure is applied, as by a wheel, at a first end of the insert pushing the insert into the cavity at a given location along the length of the insert, namely at the end. With the insert installed at the first end, the force of the wheel is progressively moved along the lengths of the insert and cavity, progressively forcing the insert into the cavity as the lateral force of the wheel moves along the length of the insert and the cavity. Thus a wheel can be used to apply the force at one end of the insert, whereupon the force can be maintained on the wheel, and the insert and jamb moved progressively past the wheel while the wheel continues to apply the lateral pressure, thus to progressively move the insert into the cavity, along the length of the insert. Thus, in the assemblage of insert 30 and jamb 24, insert 30 is frictionally and/or mechanically housed in cavity 28.

In the alternative, insert 30 can be slidingly inserted into cavity 28, longitudinally along the length of the cavity. Insert 30 and/or cavity 28 can be lubricated with e.g. wet or dry lubricant as necessary or desired. The other insert embodiments 233, 333, 433 can be assembled into their respective rear cavities 231, 331, 431 in the same manner.

In some embodiments, side jamb assembly 20 includes a plurality of jamb components in vertical alignment with each other, e.g. “stacked” on top of each other. Namely, side jamb assembly 20 can include an upper member and a lower member. The upper member has a length, and defines at least one cavity 28 which extends along its length. The lower member defines an insert portion received into the cavity and an extension portion which is made of a durable rot and decay resistant material such as at insert 30. The extension portion extends downwardly from the lower edge of the upper member a distance sufficient to substantially avoid travel of liquid water, by surface tension, from a lower edge of the lower member to a lower edge of the upper member. Exemplary lengths of extension of the extension portion include at least about two inches, at least about four inches, at least about six inches, at least about ten inches, at least about twenty inches, at least about thirty inches, and all incremental dimensions between two inches and 30 inches.

To install the door frame, the rough opening must first be “framed into” the building/structure. This is not typically done by the door installer, rather is typically done by the carpenter, and/or other onsite worker, building the building/structure. Namely, the onsite e.g. framing contractor installs appropriate header and side studs, such as framing members 82, sufficiently strong and durable to support the span of the rough opening, and the door to be installed therein.

Next, the onsite framing contractor installs the corresponding door frame and optionally the door slab. The onsite worker can install the frame as separate components in sequence, e.g. jamb assemblies 20 (which may or may not include nosing 26), header assembly 22, any casing 60, 62 and/or others. In the alternative, the installer can pre-assemble the frame on site, or at a remote location, and “tip” the finished jamb assembly, starting from a horizontal orientation, upwardly into a generally vertical orientation and thus into the rough opening, and can subsequently secure the door frame to e.g. the framing members using e.g. nail fins and/or fasteners through insert 30, 233, 333, 433.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A door jamb adapted to be received into a doorway rough opening defined by framing members in a building, as part of a door frame being received into such doorway rough opening, said door jamb having a length, a rough opening side adapted and configured to face such framing members at such rough opening when said door jamb is mounted to such building at such rough opening, and an opposing side adapted and configured to face across such rough opening, said door jamb comprising:
(a) a fiber-reinforced pultruded polymeric molding, said pultruded molding defining a pultruded jamb element having a length and a rear, said pultruded polymeric molding, when mounted in such rough opening as part of such door frame, comprising
(i) a first jamb side panel adapted and oriented to face toward such framing members at such doorway rough opening,
(ii) a second jamb side panel adapted and oriented to face across such doorway rough opening,
(iii) an outer jamb panel adapted and oriented to face outwardly away from such building, and
(iv) a rear cavity extending along the length of said pultruded jamb element, the rear cavity having a rearwardly-facing opening facing into such building, the rear cavity having first and second side walls, and a front wall, said first and second side walls extending rearwardly from said front wall to first and second respective terminal ends, said first and second terminal ends being equidistant from said front wall.

2. A door jamb as in claim 1, further comprising an insert in the rear cavity, said insert extending rearwardly of said pultruded polymeric jamb element.

3. A door jamb as in claim 2, composition of said insert being such that said insert can be fastened to such building by driving driveable fasteners through said insert and into such framing members.

4. A door jamb as in claim 2 wherein said insert is made of hydrophobic polymeric resin, optionally including filler material, and wherein said insert does not readily absorb substantial quantities of water.

5. A door jamb as in claim 2, said insert being sized and configured so as to fit closely against said first and second side walls and said front wall of said cavity whereby said insert adds substantial rigidity to said door jamb.

6. A door jamb as in claim 1, further comprising locking structure on said pultruded jamb element, extending outwardly of such building from said outer panel.

7. A door jamb as in claim 6, said locking structure comprising first locking structure, further comprising, as a separate and distinct element, a pultruded nosing, said nosing defining second locking structure, locking said pultruded nosing to said jamb element at said first locking structure.

8. A door jamb as in claim 1, the rear cavity being defined at least in part by said first and second side walls, and said front wall, each of said first and second side walls having one or more protuberances extending therefrom, into the rear cavity and toward the other of said first and second side walls, said protuberances being spaced from both said front wall and the respective said first and second terminal ends.

9. A door jamb as in claim 1, said front wall being displaced from said outer jamb panel.

10. A door frame made using a door jamb as in claim 1, said door frame being a garage door frame.

11. A door frame made using a door jamb as in claim 1, said door frame being an entry door frame.

12. A door frame made using first and second side door jambs, and a header jamb, all as in claim 1, said header jamb having an end which defines a joint with one of said first and second side jambs, further comprising a clip which extends across the joint, and which clip engages locking elements in one said side jamb and in said header jamb, thereby to control movement of a respective said end of said header jamb and the corresponding end of the respective said side jamb with respect to each other, in directions toward and/or away from such building.

13. A door jamb adapted to be received into a doorway rough opening defined by framing members in a building, as part of a door frame being received into such doorway rough opening, said door jamb having a length, a rough opening side adapted and configured to face such framing members at such rough opening when said door jamb is mounted at such rough opening, and an opposing side adapted and configured to face across such rough opening, said door jamb comprising:
(a) a pultruded frame member defining a pultruded jamb element having a length and a rear, said pultruded frame element, when mounted in such rough opening as part of such door frame, comprising
(i) a first jamb side panel adapted and oriented to face toward such framing members at such doorway rough opening,
(ii) a second jamb side panel adapted and oriented to face across such doorway rough opening,
(iii) an outer jamb panel adapted and oriented to face outwardly away from such building, and
(iv) a rear cavity having a rearwardly-facing opening facing into such building, the rear cavity having first and second side walls, and a front wall displaced from said outer jamb panel, said first and second side walls extending rearwardly from said front wall to first and second respective terminal ends; and
(b) an insert in the rear cavity, said insert extending rearwardly and/or downwardly of said first and second side walls of said cavity, abutting surfaces of said insert and said first and second side walls interfacing with each other in the cavity between said front wall and the first and second terminal ends thus to prevent said insert from moving rearwardly out of the cavity.

14. A door jamb as in claim 13 composition of said insert being such that said insert can be fastened to such building by driving driveable fasteners through said insert and into such framing members.

15. A door jamb as in claim 13 wherein said insert is made of hydrophobic polymeric resin, optionally including filler material, and wherein said insert does not readily absorb substantial quantities of water.

16. A door jamb as in claim 13, said insert being sized and configured so as to fit closely against said first and second side walls and said front wall of said cavity whereby said insert adds substantial rigidity to said door jamb.

17. A door jamb as in claim 13, the rear cavity being defined at least in part by said first and second side walls, and said front wall, each of said first and second side walls having one or more protuberances extending therefrom, into the rear cavity and toward the other of said first and second side walls, said protuberances being spaced from both said front wall and the respective said first and second terminal ends.

18. A door frame made using a door jamb as in claim 13, said door frame being a garage door frame.

19. A door frame made using a door jamb as in claim 13, said door frame being an entry door frame.

20. A door frame made using first and second side door jambs, and a header jamb, all as in claim 13, said header jamb having an end which defines a joint with one of said first and second side jambs, further comprising a clip which extends across the joint, and which clip engages locking elements in one said side jamb and in said header jamb, thereby to control movement of a respective said end of said header jamb and the corresponding end of the respective said side jamb with respect to each other, in directions toward and/or away from such building.

21. A door frame adapted to be mounted in a rough opening in a building, said door frame comprising first and second side jamb assemblies, and a header jamb assembly extending between the first and second side jamb assemblies, at least one said side jamb assembly having a polymeric upper member and a fiber-reinforced pultruded lower member, the upper member having a length, and a first lower end, and defining at least one cavity extending along the length thereof, said pultruded lower member defining an upper portion received into the cavity and a lower extension portion extending downwardly from the cavity to a second lower end of said extension portion, the extension portion being defined by a durable, rot resistant and decay resistant material.

22. A door frame as in claim 21 wherein said upper member extends along a substantial portion of the length of said side jamb assembly.

23. A door frame as in claim 21 wherein a portion of said pultruded lower member abuts against an edge or surface of the upper member of said jamb assembly.

24. A door frame as in claim 21, said polymeric upper member comprising a jamb member having an outer panel adapted and oriented to face outwardly, away from such building, said polymeric upper member further comprising a nosing adapted and configured to extend outwardly, away from such building relative to said outer panel, said nosing and said jamb member being defined in a common unitary body.

25. A door frame as in claim 21, said upper member having a first side panel adapted and configured to face across such doorway rough opening, a second opposing side panel adapted and oriented to face away from such rough opening, an outer jamb panel adapted and oriented to face away from such building, and an inner jamb panel, displaced from said outer jamb panel, displaced from said outer jamb panel, and adapted and configured to face inwardly into such building, a rear of said upper member extending rearwardly of said inner panel to terminal ends of said first and second side panels, said insert portion of said lower member extending along the length of said upper member, and rearwardly of said terminal ends of said first and second side panels.
